(19) United States
(12) Patent Application Publication
(10) Pub. No.: US 2017/0315945 A1
(43) Pub. Date: Nov. 2, 2017

(54) SIGNAL TRANSMISSION MODULE WITH A USB TYPE-C SOCKET CONNECTOR

(71) Applicant: CHING SHUN WANG, New Taipei City (TW)

(72) Inventor: CHING SHUN WANG, New Taipei City (TW)

(21) Appl. No.: 15/139,342

(22) Filed: Apr. 27, 2016

(51) Int. Cl. G06F 13/38; G06F 1/32; G06F 13/40; G06F 13/42

(52) U.S. Cl. CPC G06F 13/385; G06F 13/4282; G06F 1/3287; G06F 13/4081

(57) ABSTRACT

A signal transmission module with a USB Type-C socket connector, comprising a circuit substrate, a USB Type-C female electrical connector, a central processing unit, at least one multi-media output device and a power control unit, which are electrically connected to each other, wherein, the central processing unit computes and processes a first signal supplied by the USB Type-C socket connector and generates a second signal, which is transmitted to the multi-media output device, and the power control unit is to regulate an initial electric power, generate an regulated electric power, and transmit it to the circuit substrate, the USB Type-C female electrical connector, the central processing unit and the multi-media output device.

### BACKGROUND OF INVENTION

### 1. Field of the Invention

The present invention relates generally to a signal transmission module and more particularly to a signal transmission module with a USB Type-C socket connector.

### 2. Description of Related Art

Cars have become one of the main means of transportation for modern people. For convenience, cars are equipped with more and more electronic devices, for example, a charger for electronic products, an adapter for MP3 players, or an audio and video system. Generally, the audio and video panel in a car is provided with a USB socket. When making a connection to the USB socket, the user must insert the USB plug of a data transmission cable into the USB socket. After connection, data transmission between the two electronic devices can be realized.

However, a common USB connector only has one single socket space, i.e., the user can make connection only from one direction. If reversed, connection is not possible. Hence, the organization promoting USB (USB IF) proposed a new type of USB interface called “USB Type-C”. The essential feature of the new-type USB Type-C interface is: it includes two rows of signal terminals, and a metal plate located between the upper row and lower row. With such a configuration, its usability is enhanced. Users no longer need to worry about the direction of insertion. In another word, the new USB Type-C interface with one upper and one lower row of signal terminals allows connection from both directions.

Therefore, how to integrate USB Type-C into automotive audio and video systems has become a direction of research and improvement for the inventor of the present invention as well as relevant manufacturers in this field.

### SUMMARY OF THE INVENTION

The main object of the present invention is to provide a signal transmission module with a USB Type-C socket connector. Through a circuit substrate, a USB Type-C female electrical connector, a central processing unit, at least one multi-media output device and a power control unit, which are electrically connected to each other, the signal transmission module with a USB Type-C socket connector can be applied in electrical devices for vehicles.

To accomplish the above object, the present invention provides a signal transmission module with a USB Type-C socket connector, which comprises a circuit substrate, a USB Type-C female electrical connector, a central processing unit, at least one multi-media output device and a power control unit, which are electrically connected to each other, wherein, said central processing unit computes and processes a first signal supplied by the USB Type-C socket connector, and generates a second signal; said multi-media output device is installed in the vehicle body and is to receive the second signal generated by the central processing unit; said power control unit is to regulate an initial electric power, generate an regulated electric power and transmit it to the circuit substrate, the USB Type-C female electrical connector, the central processing unit and the multi-media output device.

To further understand the characteristics, features and technical contents of the present invention, please refer to the detailed descriptions and accompanying drawings of an embodiment of the present invention. However, the accompanying drawings are provided only for the purpose of describing the embodiment of the present invention, and are not intending to limit the present invention.

### BRIEF DESCRIPTION OF THE DRAWINGS

FIG. 1 is Block Diagram I of the present invention.

FIG. 2 is Block Diagram II of the present invention.

FIG. 3 is an external view of the present invention installed in a car.

FIG. 4 is an external view of the present invention and the USB Type-C male electrical connector.

FIG. 5 is an external view of the USB Type-C male electrical connector of the present invention installed with a circuit substrate.

FIG. 6 is an external view of the USB Type-C male electrical connector of the present invention externally bonded with a connector shell.

### DETAILED DESCRIPTION OF THE INVENTION

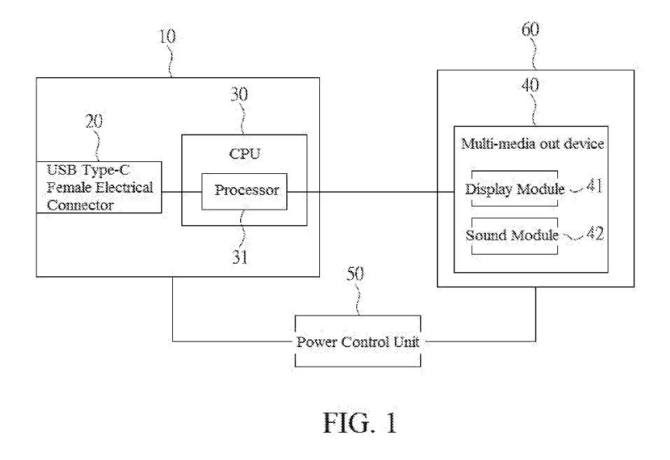

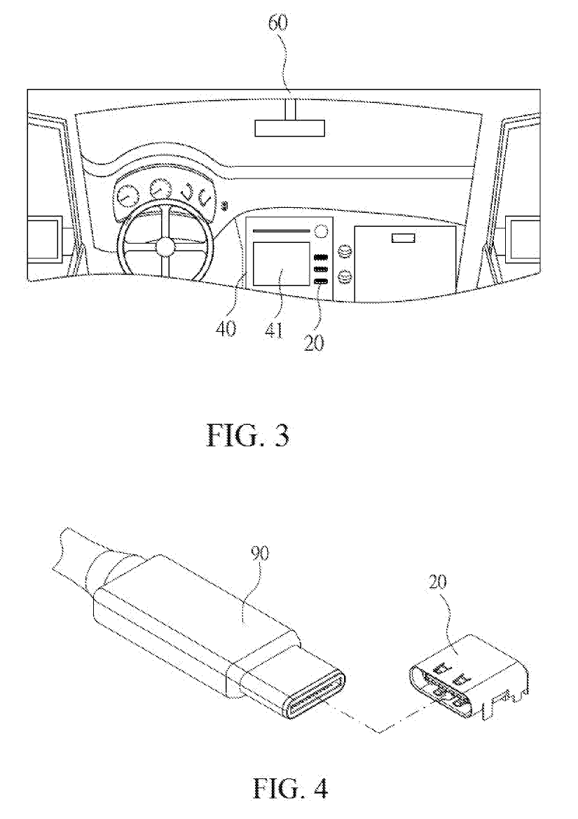

A first embodiment of the present invention of a signal transmission module with a USB Type-C socket connector is disclosed in FIG. 1-4. The signal transmission module with a USB Type-C socket connector is used in a vehicle body 60 and comprises a circuit substrate 10, a USB Type-C female electrical connector 20, a central processing unit 30, at least one multi-media output device 40 and a power control unit 50 that are electrically connected to each other. Said USB Type-C female electrical connector 20 can be connected by a USB Type-C male electrical connector 90 for transmission of signals.

In the present embodiment, the USB Type-C socket connector 20 has a transmission conductor set complying with USB3.0 specifications for transmission of signals. However, this is just an example of the present embodiment. In actual implementation, a transmission conductor set complying with USB2.0 specifications is also applicable. The central processing unit 30 has a processor 31 electrically connected to the circuit substrate 10, and the processor 31 is used to compute and process the first signal provided by the USB Type-C socket connector 20, and to convert it into a second signal, and then transmit it to the multi-media output device 40.

The second signal generated by the processor 31 after computation and processing includes an image signal and a sound signal, while the multi-media output device 40 includes a display module 41 and a sound module 42 that are respectively and electrically connected to the circuit substrate 10, wherein the display module 41 is to receive the image signal generated by the processor 31, while the sound module 42 is to receive the sound signal generated by the processor 31. The display module 41 can be an LCD in the present embodiment. However, this is just an example. In actual applications, it can be any kind of display module 41 that fits the vehicle body 60, and can receive and display the image signal. The sound module 42 can be a car audio system in the present embodiment. However, this is just an example. In actual applications, it can be any kind of sound module 42 that fits the vehicle body 60, and can receive and output the sound signal.

The power control unit 50 is to regulate an initial electric power, generate a regulated electric power and transmit it to the circuit substrate 10, the USB Type-C female electrical connector 20, the central processing unit 30, and the multi-media output device 40. In the present embodiment, the initial electric power refers to the electric power generated by the battery installed in the vehicle body 60, and the regulated electric power refers to the electric power generated after regulation by the power control unit 50 to suit the circuit substrate 10, the USB Type-C female electrical connector 20, the central processing unit 30, and the multi-media output device 40.

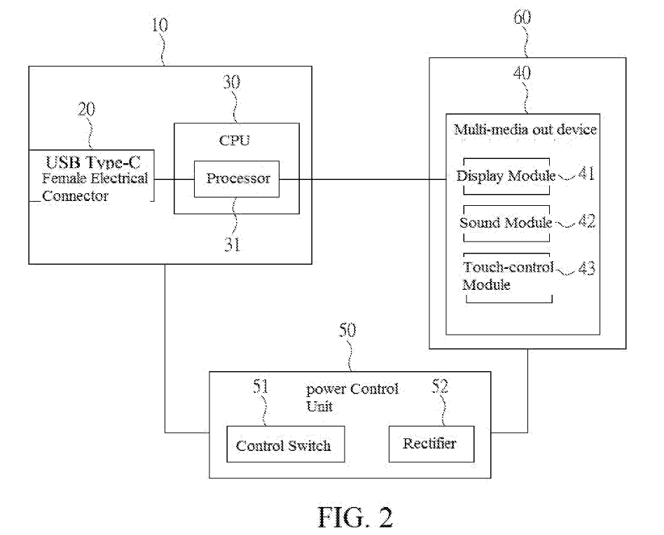

A second embodiment of the present invention of a signal transmission module with a USB Type-C socket connector is disclosed in FIG. 2. The signal transmission module with a USB Type-C socket connector is used in a vehicle body 60 and comprises a circuit substrate 10, a USB Type-C female electrical connector 20, a central processing unit 30, at least one multi-media output device 40, and a power control unit 50 that are electrically connected to each other.

In the present embodiment, the USB Type-C socket connector 20 has a transmission conductor set that complies with USB3.0 specifications for signal transmission. However, this is just an example of the present embodiment. In actual implementation, it can also be a transmission conductor set that complies with USB2.0. The central processing unit 30 has a processor 31 that is electrically connected to the circuit substrate 10, and the processor 31 is to compute and process the first signal provided by the USB Type-C socket connector 20, convert it into a second signal, and transmit it to the multi-media output device 40.

The second signal generated after computation and processing by the processor 31 includes an image signal and a sound signal, while the multi-media output device 40 includes a display module 41, a sound module 42, and a touch-control module 43 that are respectively and electrically connected to the circuit substrate 10. The display module 41 is to receive the image signal generated by the processor 31, the sound module 42 is to receive the sound signal generated by the processor 31, and the touch-control module 43 is to generate a third signal, when a user touches the display interface of the display module 41, and transmit it to the processor 31 of the central processing unit 30. The processor 31 converts the third signal provided by the touch-control module 43, and, after computation and processing, generates a fourth signal, and return it to the display module 41 or the sound module 42 of the multi-media output device 40. The display module 41 can be an LCD in the present embodiment. However, this is just an example. In actual applications, it can be any kind of display module 41 that fits the vehicle body 60 and can receive and display the image signal. The sound module 42 in the present embodiment can be a car audio system. However, this is just an example. In actual applications, it can be any kind of sound module 42 that fits the vehicle body 60, and can receive and output the sound signal.

The power control unit 50 is to regulate an initial electric power, generate a regulated electric power, and transmit it to the circuit substrate 10, the USB Type-C female electrical connector 20, the central processing unit 30, and the multi-media output device 40. In the present embodiment, the initial electric power refers to the electric power generated by the battery installed in the vehicle body 60, and the regulated electric power refers to the electric power generated after regulation by the rectifier 52 of the power control unit 50 to suit the circuit substrate 10, the USB Type-C female electrical connector 20, the central processing unit 30, and the multi-media output device 40. The purpose of the above-mentioned regulation by the rectifier 52 is to convert the initial electric power into an electric power that suits the circuit substrate 10, the USB Type-C female electrical connector 20, the central processing unit 30, and the multi-media output device 40. It may be a conversion between direct current and alternating current, or a conversion of voltage. In the present embodiment, the power control unit 50 has a control switch 51 to turn on or off the initial electric power supplied by the vehicle body 60.

Thus, through the circuit substrate 10, the USB Type-C female electrical connector 20, the central processing unit 30, the multi-media output device 40, and the power control unit 50, the present invention of a signal transmission module with a USB Type-C socket connector can be applied in automotive electronic systems.

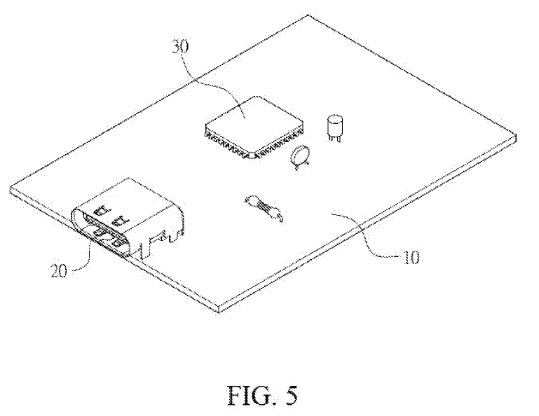

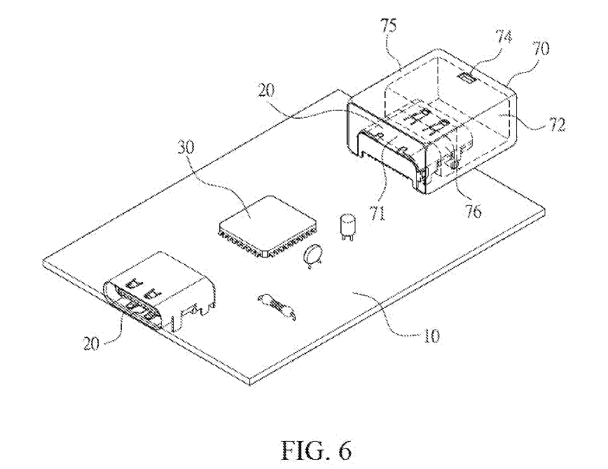

The signal transmission module with a USB Type-C socket connector 20 further comprises a connector shell 70. Said connector shell 70 can be a rectangular shell. But without limitation, it can also be implemented as a round shell or a shell of any other shape. Moreover, the connector shell 70 is a structure made of plastic material, with internal formation of a plugging slot 72 and a connecting slot 71 that are connected to each other. The size of the plugging slot 72 matches the size of the shielding shell of the USB Type-C male electrical connector 90, so as to hold the USB Type-C male electrical connector 90, while the front end of the USB Type-C socket connector 20 is fitted into the connecting slot 71. The size of the connecting slot 71 matches the size of the butt shell of the USB Type-C male electrical connector 90, so as to plug the shell. In addition, in actual implementation, a through hole 76 can be configured inside the connector shell 70, for the front end of the USB Type-C socket connector 20 to go through to the plugging slot 72. The connection method is not limited to the style that the connector shell 70 of the USB Type-C female electrical connector 20 covers the butt shell of the USB Type-C male electrical connector 90. In another embodiment, it can also be a style that the butt shell of the USB Type-C male electrical connector 90 covers the connector shell 70 of the USB Type-C female electrical connector 20. Based on the above, it can be applied in an automotive audio-video panel for external plugging by the user (as shown in FIG. 5), or, the USB Type-C female electrical connector 20 can be applied in an automotive audio-video panel for internal connection and installation (as shown in FIG. 6).

In addition, the connector shell 70 includes a fixing structure 74. The fixing structure 74 is located on the outer side of the connector shell 70. The fixing structure 74 can be a concave structure or a convex structure. The concave structure can have a hole, and the convex structure can have a lug. Here, a clasping method is used for fixation. But not limited to this, in actual implementation, it can be any other fixation method like interference fastening, screw locking, or magnetic absorption. In the example of automotive male electrical connector, the fixing structure 74 and positioning structure can facilitate clasping and fast removal.

In some other embodiments, the connector shell 70 can also be provided with a metal shell body 75. Said shell body 75 covers the connector shell 70 to block interference from foreign signals.

Based on the above detailed descriptions, a person skilled in the relevant art can understand that the present invention can truly accomplish the afore-mentioned object. Given that the present invention truly meets the specifications of the Patent Law, a patent application is filed. Although the invention has been explained in relation to its preferred embodiment, it is to be understood that many other possible modifications and variations can be made without departing from the spirit and scope of the invention as hereinafter claimed.

1. A signal transmission module with a USB Type-C socket connector, used in a vehicle body, said signal transmission module with a USB Type-C socket connector comprising:
a circuit substrate;
a USB Type-C female electrical connector, electrically connected to the circuit substrate;
a central processing unit, electrically connected to the circuit substrate, said central processing unit computing and processing a first signal supplied by the USB Type-C socket connector, and generating a second signal;
at least one multi-media output device, installed on the vehicle body and electrically connected to the circuit substrate, said multi-media output device receiving the second signal generated by the central processing unit; and
a power control unit, electrically connected to the circuit substrate, which is to regulate an initial electric power from the vehicle body, generate a regulated electric power, and transmit it to the circuit substrate, the USB Type-C female electrical connector, the central processing unit, and the multi-media output device.

2. The signal transmission module with a USB Type-C socket connector as claimed in claim 1, which further comprises a connector shell, said connector shell including a connecting slot to hold the USB Type-C female electrical connector, and a plugging slot, which are connected to each other; said plugging slot connects the butt shell of the automotive male electrical connector, and the automotive male electrical connector connects the USB Type-C female electrical connector.

3. The signal transmission module with a USB Type-C socket connector as claimed in claim 2, wherein the outer side of the connector shell includes a fixing structure that clasps the positioning structure of the automotive male electrical connector.

4. The signal transmission module with a USB Type-C socket connector as claimed in claim 2, wherein said connector shell is covered by an enclosure.

5. The signal transmission module with a USB Type-C socket connector as claimed in claim 2, wherein said connector shell includes a through hole, located between the connecting slot and the plugging slot, connecting the connecting slot and the plugging slot.

6. The signal transmission module with a USB Type-C socket connector as claimed in claim 1, wherein said central processing unit has a processor electrically connected to the circuit substrate, said processor converting the first signal supplied by the USB Type-C socket connector and generating the second signal.

7. The signal transmission module with a USB Type-C socket connector as claimed in claim 1, wherein said second signal includes an image signal and a sound signal.

8. The signal transmission module with a USB Type-C socket connector as claimed in claim 5, wherein said multi-media output device includes a display module and a sound module, electrically and respectively connected to the circuit substrate, said display module receiving the image signal generated by the central processing unit, and said sound module receiving the sound signal generated by the central processing unit.

9. The signal transmission module with a USB Type-C socket connector as claimed in claim 1, wherein said multi-media output device includes a touch-control module; said touch-control module is electrically connected to the circuit substrate, and generates a third signal and transmits it to the central processing unit, and the central processing unit converts the third signal supplied by the touch-control module, and generates a fourth signal and returns it to the multi-media output device.

10. The signal transmission module with a USB Type-C socket connector as claimed in claim 1, wherein said power control unit is provided with a control switch to turn on or off the initial electric power from the power supply device.
